(19) United States
(12) Patent Application Publication
(10) Pub. No.: US 2025/0360625 A1
(43) Pub. Date: Nov. 27, 2025

(54) Moving Device and Assembly Device

(71) Applicant: Tyco Electronics (Shanghai) Co., Ltd., Shanghai (CN)

(72) Inventors: Huabin Du, Shanghai (CN); Yichao (Tony) Ni, Shanghai (CN); Jian Cao, Shanghai (CN); Fengchun (Fred) Xie, Shanghai (CN); Lvhai (Samuel) Hu, Shangai (CN)

(73) Assignee: Tyco Electronics (Shanghai) Co., Ltd., Shanghai (CN)

(21) Appl. No.: 19/219,292

(22) Filed: May 27, 2025

(30) Foreign Application Priority Data
May 27, 2024 (CN) 202410667958.X

(51) Int. Cl. B25J 9/16; B25J 13/08

(52) U.S. Cl. CPC B25J 9/1687; B25J 13/088

(57) ABSTRACT

A moving device comprises a fixed plate, a vertical plate, a sliding member and an installation plate. The fixed plate is adapted to be fixed to a rack. The vertical plate is fixed on the fixed plate and is formed with a U-shaped groove. The sliding member is slidably engaged with the U-shaped groove. The installation plate is adapted to support a gripper and is connected to the sliding member so as to be movable together with the sliding member. As the sliding member slides between two ends of the U-shaped groove, the gripper installed on the installation plate is moved between a first working position and a second working position.

### CROSS-REFERENCE TO RELATED APPLICATION

This application claims the benefit of Chinese Patent Application No. CN202410667958.X filed on May 27, 2024 in the State Intellectual Property Office of China, the whole disclosure of which is incorporated herein by reference.

### FIELD OF THE DISCLOSURE

The present disclosure relates to a moving device and an assembly device comprising the moving device.

### BACKGROUND OF THE INVENTION

In the prior art, visual robots are commonly used to perform connector assembly operations. However, visual robots have problems such as high cost and complex control.

### SUMMARY OF THE INVENTION

According to an embodiment of the present disclosure, a moving device comprises a fixed plate, a vertical plate, a sliding member and an installation plate. The fixed plate is adapted to be fixed to a rack. The vertical plate is fixed on the fixed plate and is formed with a U-shaped groove. The sliding member is slidably engaged with the U-shaped groove. The installation plate is adapted to support a gripper and is connected to the sliding member so as to be movable together with the sliding member. As the sliding member slides between two ends of the U-shaped groove, the gripper installed on the installation plate is moved between a first working position and a second working position.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of an assembly device according to an exemplary embodiment of the present invention;

FIG. 2 shows an illustrative perspective view of the moving device of the assembly device according to an exemplary embodiment of the present invention;

FIG. 3 shows an illustrative perspective view of an assembly device according to an exemplary embodiment of the present invention, where the first and second carriers are not shown; and

FIG. 4 shows an illustrative perspective view of the rack, first carrier, and second carrier of an assembly device according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure a moving device comprises: a fixed plate adapted to be fixed to a rack; a vertical plate fixed on the fixed plate and formed with a U-shaped groove; a sliding member that is slidably engaged with the U-shaped groove and can slide along the U-shaped groove; and an installation plate that is used to install a gripper and is connected to the sliding member so as to be able to move together with the sliding member. When the sliding member slides between two ends of the U-shaped groove, the gripper installed on the installation plate is moved between a first working position and a second working position.

According to another embodiment of the present disclosure, an assembly device comprises a rack, the above moving device, and a first gripper. The fixed plate of the moving device is fixed to the rack. The first gripper is installed on the installation plate of the moving device. The moving device is used to drive the first gripper to move between a first gripping position for gripping a first component and a first installation position for installing the first component.

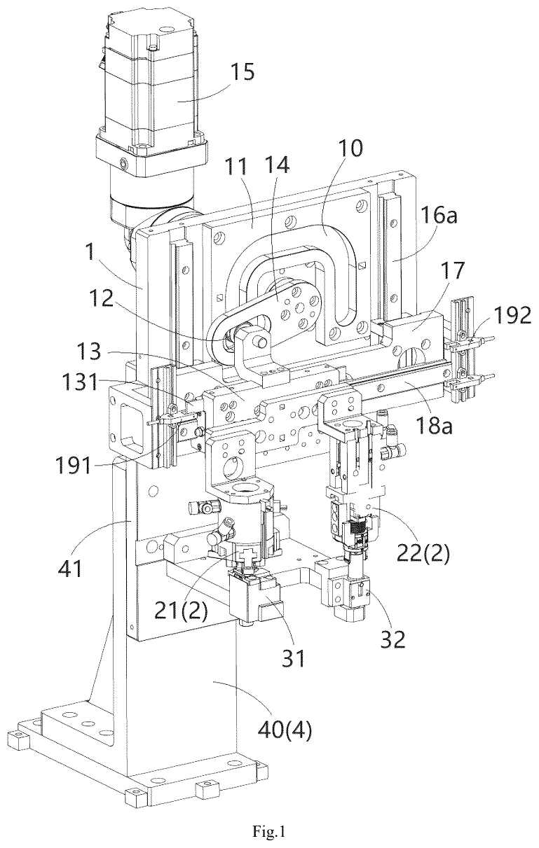

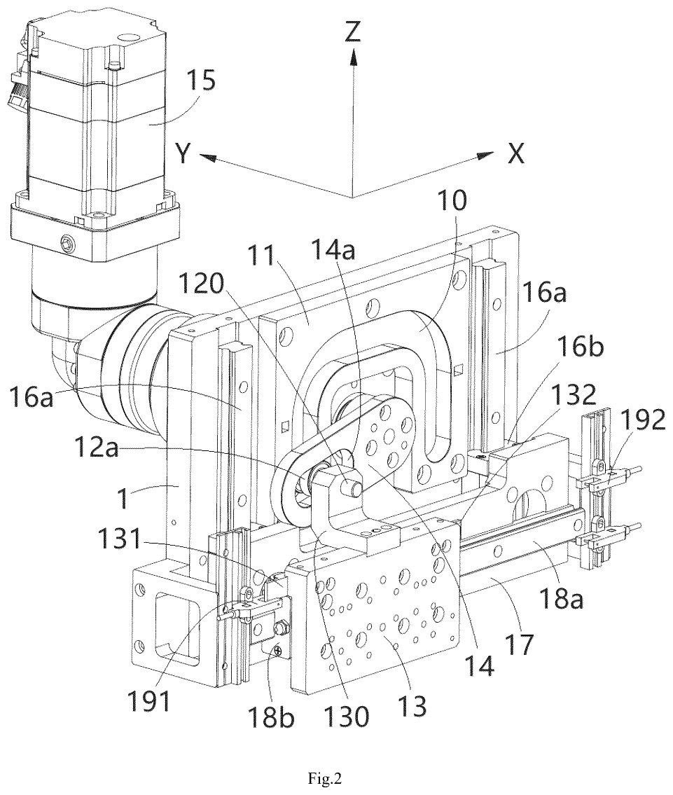

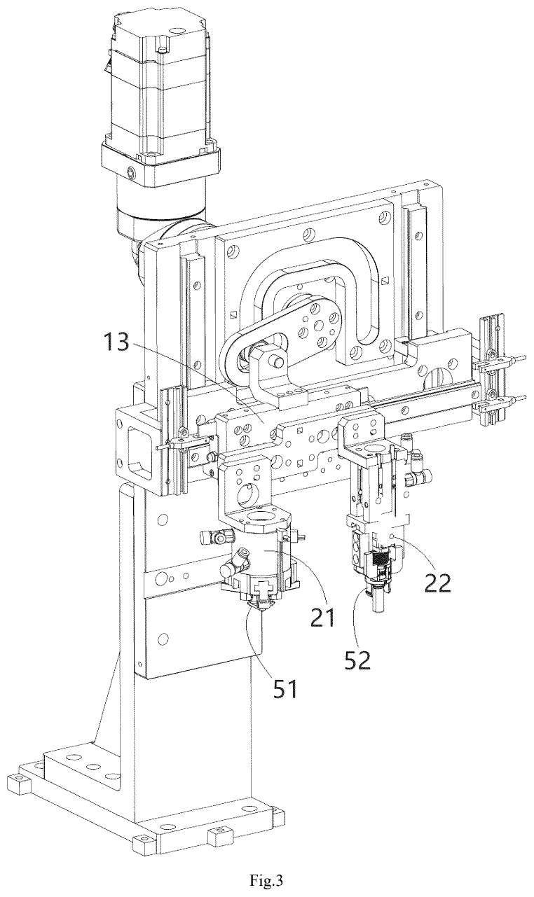

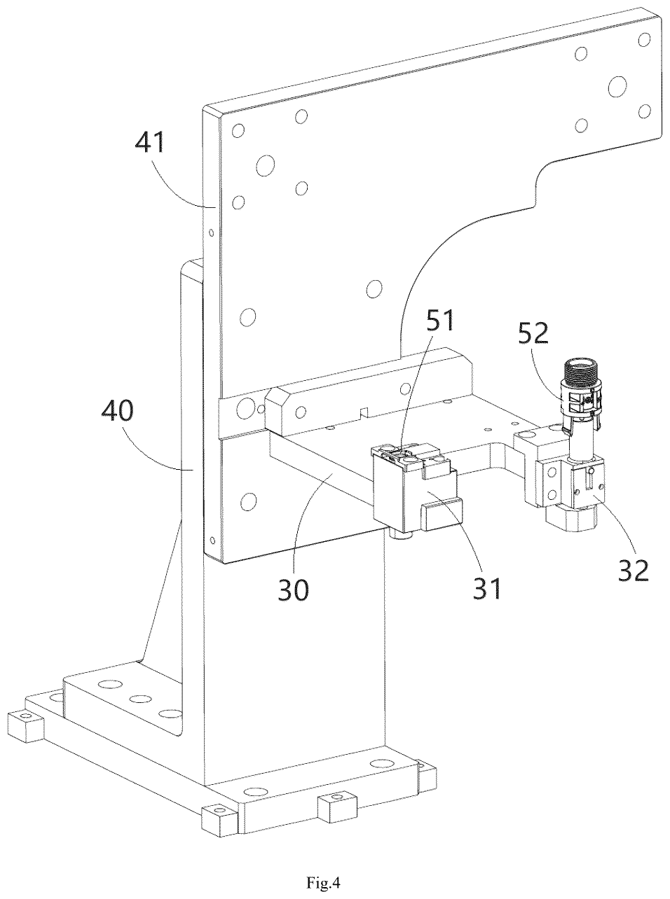

FIG. 1 shows an illustrative perspective view of an assembly device according to an exemplary embodiment of the present invention. FIG. 2 shows an illustrative perspective view of the moving device of the assembly device according to an exemplary embodiment of the present invention. FIG. 3 shows an illustrative perspective view of an assembly device according to an exemplary embodiment of the present invention, where the first carrier 31 and the second carrier 32 are not shown. FIG. 4 shows an illustrative perspective view of the rack 4, first carrier 31, and second carrier 32 of an assembly device according to an exemplary embodiment of the present invention.

As shown in FIGS. 1-4, in an exemplary embodiment of the present disclosure, a moving device is disclosed. The moving device includes: a fixed plate 1, a vertical plate 11, a sliding member 12, and an installation plate 13. The fixed plate 1 is adapted to be fixed on a rack 4. The vertical plate 11 is fixed on the fixed plate 1 and formed with a U-shaped groove 10. The sliding member 12 is slidably engaged with the U-shaped groove 10 and can slide along the U-shaped groove 10. The installation plate 13 is used to install a gripper 2 and is connected to the sliding member 12 to be able to move together with the sliding member 12. When the sliding member 12 slides between the two ends of the U-shaped groove 10, the gripper 2 installed on the installation plate 13 is moved between a first working position and a second working position.

In the illustrated embodiment, the first working position and the second working position are opposite and spaced apart in the first horizontal direction X parallel to the vertical plate 11. The installation plate 13 and the vertical plate 11 are opposite and spaced apart in the second horizontal direction Y perpendicular to the vertical plate 11.

The sliding member 12 includes a rod-shaped part 120 and a roller-shaped portion 12a formed on one end of the rod-shaped part 120, which is slidably mounted in the U-shaped groove 10. The rod-shaped part 120 is perpendicular to the vertical plate 11, and the other end of the rod-shaped part 120 is connected to the installation plate 13.

The moving device further comprises a connecting piece 130, which is L-shaped and connected between the rod-shaped part 120 and the installation plate 13. A mounting hole is formed in one end of the connecting piece 130, and the other end of the rod-shaped part 120 is installed into the mounting hole. The other end of the connecting piece 130 is fixed to the installation plate 13.

The moving device further comprises a rotating arm 14, which is rotatably mounted on the fixed plate 1 and can be rotated around an axis perpendicular to the vertical plate 11 between a first angular position and a second angular position. A radial slot 14a perpendicular to the axis is formed in the rotating arm 14, and the sliding member 12 passes through the radial slot 14a and slides in cooperation with it to be able to slide along the radial slot 14a. When the rotating arm 14 is rotated between the first angle position and the second angle position, the sliding member 12 is slid along the U-shaped groove 10 and the radial slot 14a under the drive of the rotating arm 14.

When the rotating arm 14 is rotated to the first angular position, the sliding member 12 is slid to one end of the U-shaped groove 10 to move the gripper 2 to the first working position. When the rotating arm 14 is rotated to the second angular position, the sliding member 12 is slid to the other end of the U-shaped groove 10 to move the gripper 2 to the second working position.

The moving device further comprises a servo motor 15, which is installed on the fixed plate 1 and its output shaft is connected to the rotating arm 14, for driving the rotating arm 14 to rotate between the first angular position and the second angular position.

The moving device further comprises: a pair of vertical sliding rails 16a, a pair of vertical sliders 16b, a vertical moving plate 17, a horizontal sliding rail 18a, and a horizontal slider 18b. The vertical slide rail 16a extends along the vertical direction Z, and the horizontal slide rail 18a extends along the first horizontal direction X. The pair of vertical sliding rails 16a are fixed to the fixed plate 1 and arranged on both sides of the vertical plate 11. The pair of vertical sliders 16b are respectively slidably installed on the pair of vertical sliding rails 16a, so as to be able to slide along the vertical slides 16a. The vertical moving plate 17 is fixed to the pair of vertical sliders 16b so as to be able to move together with the vertical sliders 16b. The horizontal slide rail 18a is fixed to the vertical moving plate 17 and extends along the first horizontal direction X parallel to the vertical plate 11. The horizontal slider 18b is slidably installed on the horizontal slide rail 18a so as to be able to slide along the horizontal slide rail 18a. The installation plate 13 is fixed to the horizontal slider 18b so as to be able to move together with the horizontal slider 18b and the vertical slider 16b.

When the sliding member 12 is moved to one end of the U-shaped groove 10 by the driving of the rotating arm 14, the installation plate 13 is moved to one end of the horizontal slide rail 18a, and the gripper 2 is moved to the first working position. When the sliding member 12 is moved to the other end of the U-shaped groove 10 by the driving of the rotating arm 14, the installation plate 13 is moved to the other end of the horizontal slide rail 18a, and the gripper 2 is moved to the second working position.

The moving device further comprises a first position sensor 191 and a second position sensor 192. The first position sensor 191 is installed on the fixed plate 1 and adjacent to one end of the horizontal slide rail 18a, used to detect whether the gripper 2 has been moved to the first working position. The second position sensor 192 is installed on the fixed plate 1 and adjacent to the other end of the horizontal slide rail 18a, used to detect whether the gripper 2 has been moved to the second working position. When gripper 2 is moved to the first working position, the first position sensor 191 is triggered. When gripper 2 is moved to the second working position, the second position sensor 192 is triggered.

The moving device further comprises a first trigger piece 131 and a second trigger piece 132. The first trigger piece 131 is installed on the installation plate 13. The second trigger piece 132 is installed on the installation plate 13. The first position sensor 191 and the second position sensor 192 may be photoelectric sensors. When the gripper 2 is moved to the first working position, the first trigger piece 131 is inserted into a first slot of the first position sensor 191 and triggers the first position sensor 191. When the gripper 2 is moved to the second working position, the second trigger piece 132 is inserted into a second slot of the second position sensor 192 and triggers the second position sensor 192.

An assembly device is also disclosed. The assembly device includes: a rack 4, a moving device, and a first gripper 2. The fixed plate 1 of the moving device is fixed to the rack 4. The first gripper 2 is installed on the installation plate 13 of the moving device. The moving device is used to drive the first gripper 2 to move between a first gripping position for gripping a first component 51 and a first installation position for installing the first component 51.

The assembly device further comprises a bracket 30, a first carrier 31, and a second carrier 32. The bracket 30 is fixed to rack 4. The first carrier 31 is installed on the bracket 30 and located at the first gripping position for loading the first component 51. The second carrier 32 is installed on the bracket 30 and located at the first installation position for loading a second component 52. The first gripper 2 grips the first component 51 from the first carrier 31 at the first gripping position and installs the gripped first component 51 onto the second component 52 loaded on the second carrier 32 at the first installation position.

The first component 51 is a sealing ring of a connector, the first carrier 31 is used to load the sealing ring, the second component 52 is a housing of the connector, and the second carrier 32 is used to load the housing. The first gripper 2 grips the sealing ring from the first carrier 31 at the first gripping position and installs the gripped sealing ring onto the housing loaded on the second carrier 32 at the first installation position.

The assembly device further comprises a second gripper 2, which is mounted on the installation plate 13 of the moving device. When the first gripper 2 is in the first gripping position, the second gripper 2 is in the first installation position, used to grip the housing that has been installed with a sealing ring. When the first gripper 2 is moved to the first installation position, the second gripper 2 is moved to a second installation position, used to move the housing to the second installation position for the next installation operation of the connector.

The rack 4 includes a base 40 and a vertical base plate 41. The vertical base plate 41 is fixed on the base 40. The bracket 30 and the fixed plate 1 are detachably mounted on the vertical base plate 41.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A moving device, comprising:
a fixed plate adapted to be fixed to a rack;
a vertical plate fixed on the fixed plate and formed with a U-shaped groove;
a sliding member slidably engaged with the U-shaped groove; and
an installation plate adapted to support a gripper and connected to the sliding member so as to be movable together with the sliding member, as the sliding member slides between two ends of the U-shaped groove, the gripper installed on the installation plate is moved between a first working position and a second working position.

2. The moving device according to claim 1, wherein the first working position and the second working position are opposite and spaced apart in a first horizontal direction parallel to the vertical plate.

3. The moving device according to claim 2, wherein the installation plate and the vertical plate are opposite and spaced apart in a second horizontal direction perpendicular to the vertical plate.

4. The moving device according to claim 3, wherein:
the sliding member includes a rod-shaped part and a roller-shaped portion formed on a first end of the rod-shaped part, the roller-shaped portion is slidably installed in the U-shaped groove; and
the rod-shaped part is perpendicular to the vertical plate, and a second end of the rod-shaped part is connected to the installation plate.

5. The moving device according to claim 4, further comprising a connecting piece that is L-shaped and connected between the rod-shaped part and the installation plate, wherein an installation hole is formed in a first end of the connecting piece, and the second end of the rod-shaped part is installed into the installation hole, a second end of the connecting piece is fixed to the installation plate.

6. The moving device according to claim 1, further comprising a rotating arm rotatably mounted on the fixed plate and rotatable around an axis perpendicular to the vertical plate between a first angular position and a second angular position.

7. The moving device according to claim 6, wherein:
a radial slot perpendicular to the axis is formed in the rotating arm, and the sliding member passes through the radial slot and slides in cooperation with the radial slot to be able to slide along the radial slot; and
when the rotating arm is rotated between the first angular position and the second angular position, the sliding member slides along the U-shaped groove and the radial slot driven by the rotating arm.

8. The moving device according to claim 7, wherein:
when the rotating arm is rotated to the first angular position, the sliding member is slid to one end of the U-shaped groove to move the gripper to the first working position; and
when the rotating arm is rotated to the second angular position, the sliding member is slid to the other end of the U-shaped groove to move the gripper to the second working position.

9. The moving device according to claim 7, further comprising a servo motor installed on the fixed plate and having an output shaft connected to the rotating arm, the servo motor driving the rotating arm to rotate between the first angular position and the second angular position.

10. The moving device according to claim 8, further comprising:
a pair of vertical sliding rails fixed to the fixed plate and arranged on both sides of the vertical plate respectively;
a pair of vertical sliders respectively installed on the pair of vertical sliding rails to slide along the vertical sliding rails;
a vertical moving plate fixed to the pair of vertical sliders so as to be movable together with the vertical sliders;
a horizontal sliding rail fixed to the vertical moving plate and extending along a first horizontal direction parallel to the vertical plate; and
a horizontal slider slidably installed on the horizontal slide rail to slide along the horizontal slide rail, wherein the installation plate is fixed to the horizontal slider so as to be able to move together with the horizontal slider and the vertical slider.

11. The moving device according to claim 10, wherein:
when the sliding member is moved to one end of the U-shaped groove by the rotating arm, the installation plate is moved to one end of the horizontal slide rail, and the gripper is moved to the first working position; and
when the sliding member is moved to the other end of the U-shaped groove by the rotating arm, the installation plate is moved to the other end of the horizontal slide rail, and the gripper is moved to the second working position.

12. The moving device according to claim 11, further comprising:
a first position sensor installed on the fixed plate and adjacent to one end of the horizontal slide rail, and adapted to detect whether the gripper has been moved to the first working position; and
a second position sensor installed on the fixed plate and adjacent to the other end of the horizontal slide rail, and adapted to detect whether the gripper has been moved to the second working position.

13. The moving device according to claim 12, wherein the first position sensor is triggered when the gripper is moved to the first working position, the second position sensor is triggered when the gripper is moved to the second working position.

14. The moving device according to claim 13, further comprising:
a first trigger piece installed on the installation plate; and
a second trigger piece installed on the installation plate.

15. The moving device according to claim 14, wherein:
when the gripper is moved to the first working position, the first trigger piece is inserted into a first slot of the first position sensor and triggers the first position sensor; and
when the gripper is moved to the second working position, the second trigger piece is inserted into a second slot of the second position sensor and triggers the second position sensor.

16. An assembly device, comprising:
a rack;
a moving device, including:
a fixed plate fixed to the rack;
a vertical plate fixed on the fixed plate and formed with a U-shaped groove;
a sliding member slidably engaged with the U-shaped groove; and
an installation plate adapted to support a gripper and connected to the sliding member so as to be able to move together with the sliding member, as the sliding member slides between two ends of the U-shaped groove, the gripper installed on the installation plate is moved between a first working position and a second working position; and
a first gripper installed on the installation plate of the moving device, wherein the moving device is adapted to drive the first gripper to move between a first gripping position for gripping a first component and a first installation position for installing the first component.

17. The assembly device according to claim 16, further comprising:
a bracket fixed to the rack;
a first carrier installed on the bracket and located at the first gripping position for loading the first component; and
a second carrier installed on the bracket and located at the first installation position, for loading a second component, wherein the first gripper grips the first component from the first carrier at the first gripping position and installs the gripped first component onto the second component loaded on the second carrier at the first installation position.

18. The assembly device according to claim 17, wherein:
the first component is a sealing ring of a connector, the first carrier is used to load the sealing ring, the second component is a housing of a connector, and the second carrier is used to load the housing; and
the first gripper grips the sealing ring from the first carrier at the first gripping position and installs the gripped sealing ring onto the housing loaded on the second carrier at the first installation position.

19. The assembly device according to claim 18, further comprising a second gripper installed on the installation plate of the moving device, wherein:
when the first gripper is in the first gripping position, the second gripper is in the first installation position and used to grip the housing that has been installed with the sealing ring; and
when the first gripper is moved to the first installation position, the second gripper is moved to a second installation position to move the gripped housing to the second installation position for the next installation operation of the connector.

20. The assembly device according to claim 17, wherein the rack comprises:
a base; and
a vertical base plate fixed on the base, wherein the bracket and the fixed plate are detachably mounted on the vertical base plate.
